(19) United States
(12) Patent Application Publication
(10) Pub. No.: US 2023/0164781 A1
(43) Pub. Date: May 25, 2023

(54) METHOD AND APPARATUS FOR TRANSMITTING AND RECEIVING SIGNAL FOR WIRELESS COMMUNICATION

(71) Applicant: LG ELECTRONICS INC., Seoul (KR)

(72) Inventors: Jaehyung Kim, Seoul (KR); Youngdae Lee, Seoul (KR); Joonkui Ahn, Seoul (KR); Hyunsoo Ko, Seoul (KR); Suckchel Yang, Seoul (KR); Seonwook Kim, Seoul (KR); Seunggye Hwang, Seoul (KR)

(21) Appl. No.: 17/923,040

(22) PCT Filed: May 17, 2021
(86) PCT No.: PCT/KR2021/006142

§ 371 Date: Nov. 3, 2022

(30) Foreign Application Priority Data
May 15, 2020 (KR) 10-2020-0058642

(51) Int. Cl. H04W 72/1273; H04W 72/51; H04W 72/23

(52) U.S. Cl. CPC H04W 72/1273; H04W 72/51; H04W 72/23

(57) ABSTRACT

A terminal performing initial cell access, according to an embodiment of the present disclosure, receives a PBCH signal through an SSB, receives SIB1-scheduling information for a first CORESET on the basis of the PBCH signal, and receives an SIB1 through a PDSCH, wherein the terminal is a second type terminal with reduced capability to support a maximum bandwidth smaller than that of a first type terminal among different types of terminals supported in a 3GPP-based wireless communication system, and even though the PBCH signal received by the terminal is set to be the same as a PBCH signal received by the first type terminal, the SIB1 received by the terminal may include a second type SIB1 different from a first type SIB1 that the first type terminal receives.

### TECHNICAL FIELD

The present disclosure relates to wireless communication, and more particularly, to a method and apparatus for cell access in a wireless communication system.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

The object of the present disclosure is to provide an efficient cell access method and apparatus therefor

The present disclosure is not limited to the above-described object, and other objects that the present disclosure could achieve will be more clearly understood from the following detailed description.

### Technical Solution

In an aspect of the present disclosure, there is provided a method of performing initial cell access by a user equipment (UE) in a 3rd generation partnership project (3GPP)-based wireless communication system. The method may include: receiving a physical broadcast channel (PBCH) signal in a synchronization signal block (SSB); receiving system information block 1 (SIB1)-scheduling information in a first control resource set (CORESET) based on the PBCH signal; and receiving an SIB1 through a physical downlink shared channel (PDSCH).

The UE may be a second type of UE with reduced capability to support a smaller maximum bandwidth than a first type of UE among different types of UEs supported in the 3GPP-based wireless communication system. Even though the PBCH signal received by the UE is configured the same as a PBCH signal received by the first type of UE, the SIB1 received by the UE may include a second type of SIB1 different from a first type of SIB1 received by the first type of UE.

The SIB1-scheduling information may include both scheduling information for the first type of SIB1 and scheduling information for the second type of SIB1.

Even though the UE receives same SIB1-scheduling information as the first type of UE, the UE may be configured to receive the second type of SIB1 that is not received by the first type of UE.

The SIB1-scheduling information may be downlink control information (DCI) received through a physical downlink control channel (PDCCH).

SIB1-scheduling information received by the first type of UE and SIB1-scheduling information received by the second type of UE may be different in at least one of a DCI size, a related radio network temporary identifier (RNTI), or cyclic redundancy check (CRC) masking. The first CORESET may be related to both the SIB1-scheduling information received by the first type of UE and the SIB1-scheduling information received by the second type of UE.

The first CORESET may be a part of a CORESET monitored by the first type of UE.

The first CORESET may be obtained by applying a specific time offset or a specific frequency offset to a CORESET monitored by the first type of UE.

The UE may be configured to receive the second type of SIB1 at a location obtained by applying a specific time offset or a specific frequency offset to a location of the first type of SIB1.

In another aspect of the present disclosure, there is provided a processor-readable storage medium configured to store a program for executing the above-described method.

In another aspect of the present disclosure, there is provided a device configured to perform initial cell access in a 3GPP-based wireless communication system. The device may include: a memory configured to store instructions; and a processor configured to execute the instructions to: receive a PBCH signal in an SSB; receive SIB1-scheduling information in a first CORESET based on the PBCH signal; and receive an SIB1 over a PDSCH. The device may be a second type of device with reduced capability to support a smaller maximum bandwidth than a first type of device among different types of devices supported in the 3GPP-based wireless communication system. Even though the PBCH signal received by the device is configured the same as a PBCH signal received by the first type of device, the SIB1 received by the device may include a second type of SIB1 different from a first type of SIB1 received by the first type of device.

The device may further include a transceiver configured to transmit and receive a radio signal under control of the processor.

The device may be a UE for the 3GPP-based wireless communication.

The device may be an application-specific integrated circuit (ASIC) or a digital signal processing device.

In another aspect of the present disclosure, there is provided a method of transmitting a signal by a base station in a 3GPP-based wireless communication system. The method may include: transmitting a PBCH signal in an SSB; transmitting SIB1-scheduling information in a first CORESET based on the PBCH signal; and transmitting an SIB1 over a PDSCH. The base station may be configured to support both a first type of UE and a second type of UE with reduced capability to support a smaller maximum bandwidth than the first type of UE. The base station may be configured to transmit a same PBCH signal commonly to the first type of UE and the second type of UE and transmit to the second type of UE a second type of SIB1 different from a first type of SIB1 for the first type of UE.

In a further aspect of the present disclosure, there is provided a base station configured to transmit a signal in a 3GPP-based wireless communication system. The base station may include: a memory configured to store instructions; and a processor configured to execute the instructions to: transmit a PBCH signal in an SSB; transmit SIB1-scheduling information in a first CORESET based on the PBCH signal; and transmit an SIB1 over a PDSCH. The processor may be configured to support both a first type of UE and a second type of UE with reduced capability to support a smaller maximum bandwidth than the first type of UE. The processor may be configured to transmit a same PBCH signal commonly to the first type of UE and the second type of UE and transmit to the second type of UE a second type of SIB1 different from a first type of SIB1 for the first type of UE.

### Advantageous Effects

According to an embodiment of the present disclosure, a user equipment (UE) with reduced capability for a maximum supportable bandwidth may perform initial cell access efficiently.

The present disclosure is not limited to the above-described effect, and other effects that the present disclosure could achieve will be more clearly understood from the following detailed description.

### DESCRIPTION OF DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates a random access procedure.

FIG. 5 illustrates an example of physical channel mapping.

FIG. 6 illustrates an exemplary acknowledgment/negative acknowledgment (ACK/NACK) transmission process.

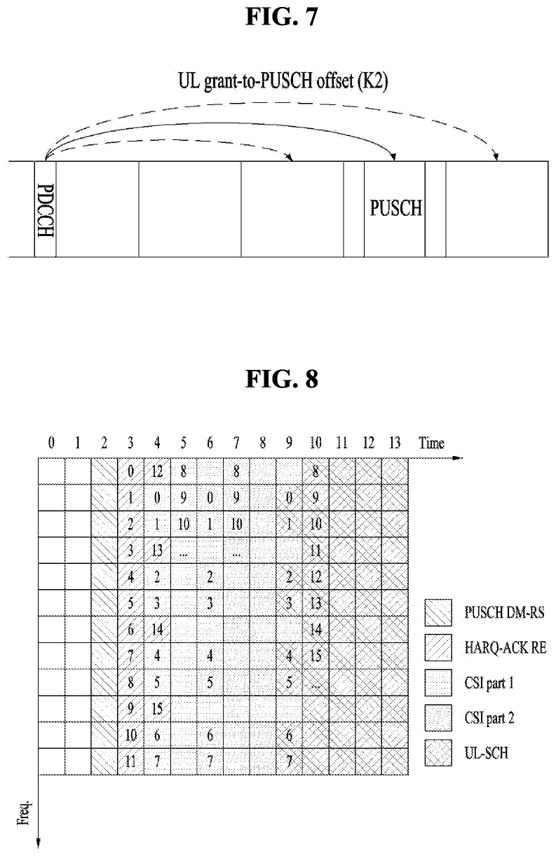

FIG. 7 illustrates an exemplary physical uplink shared channel (PUSCH) transmission process.

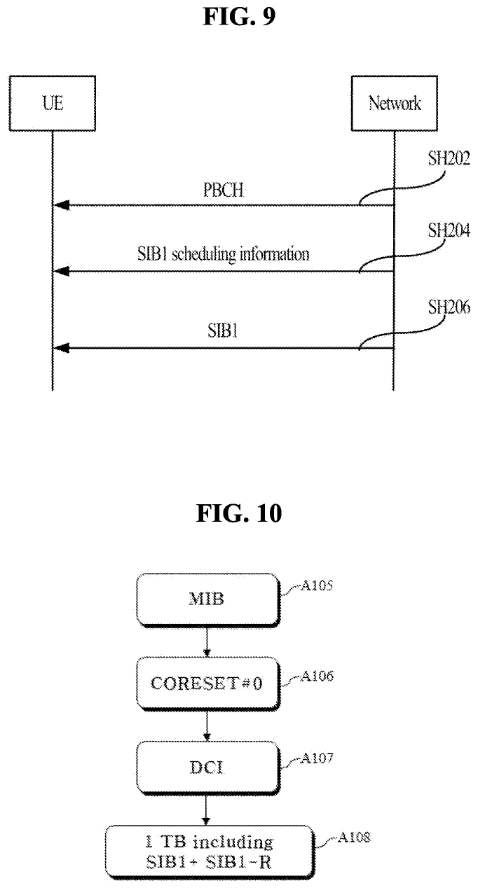

FIG. 8 illustrates an example of multiplexing control information in a PUSCH.

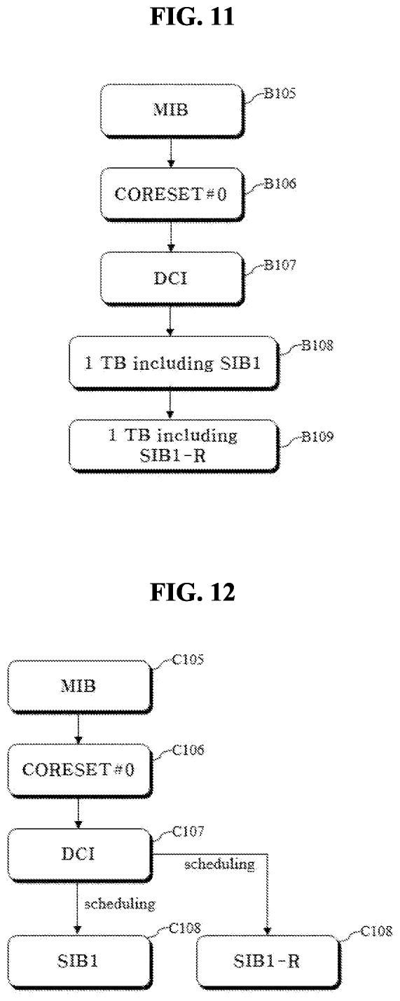

FIG. 9 illustrates exemplary cell access according to an embodiment of the present disclosure.

FIGS. 10 to 15 are diagrams for explaining system information reception during initial cell access according to embodiments of the present disclosure.

FIGS. 16 and 17 illustrate a communication system 1 and wireless devices applied to the present disclosure.

FIG. 18 illustrates a discontinuous reception (DRX) operation applicable to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto. LTE refers to technologies after 3GPP TS 36.xxx Release 8. Specifically, LTE technologies after 3GPP TS 36.xxx Release 10 are referred to as LTE-A, and LTE technologies after 3GPP TS 36.xxx Release 13 are referred to as LTE-A pro. 3GPP NR refers to technologies after TS 38.xxx Release 15. LTE/NR may be referred to as 3GPP systems. In this document, “xxx” represents the detail number of a specification. LTE/NR may be collectively referred to as 3GPP systems.

Details of the background, terminology, abbreviations, etc. used herein may be found in documents published before the present disclosure. For example, the present disclosure may be supported by the following documents:

3GPP NR
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

Technical terms used in this document
FR1: Frequency Range 1 (FR1) refers to a frequency range below 6 GHz (e.g., 450 MHz to 6000 MHz).
FR2: Frequency Range 2 (FR2) refers to a millimeter wave (mmWave) region above 24 GHz (e.g., 24250 MHz to 52600 MHz).
RNTI: Radio Network Temporary Identifier
SIB: System Information Block
SIB1: SIB1 for NR devices=RMSI (Remaining Minimum System Information).

SIB1 is used to broadcast information necessary for cell access of NR UEs.
CORESET: A control resource set (CORESET) refers to time/frequency resources on which a NR UE attempts to decode candidate PDCCHs.
CORESET#0: CORESET#0 refers to a CORESET for a Type0-PDCCH CSS set for NR devices (configured by an MIB).
Type0-PDCCH CSS set: The Type0-PDCCH CSS set refers to a search space set in which a NR UE monitors a set of PDCCH candidates for a DCI format with a CRC scrambled by an SI-RNTI.
MO: PDCCH Monitoring Occasion for Type0-PDCCH CSS set
SIB1-R: SIB1-R refers to (additional) SIB1 for reduced capability NR devices. SIB1-R may be generated as a TB different from that of SIB1 and transmitted on a different PDSCH.
CORESET#0-R: CORESET#0 for reduced capability NR devices
Type0-PDCCH-R CSS set: Type0-PDCCH-R CSS set refers to a search space set in which a RedCap UE monitors a set of PDCCH candidates for a DCI format with a CRC scrambled by an SI-RNTI.
MO-R: PDCCH Monitoring Occasion for Type0-PDCCH CSS set
Cell defining SSB: A cell defining SSB (CD-SSB) refers to an SSB including RMSI scheduling information among NR SSBs.
Non-cell defining SSB: A non-cell defining SSB (non-CD-SSB) refers to an SSB that is deployed in a NR synchronization raster but does not include RMSI scheduling information for a cell for measurement. However, the non-CD-SSB may contain information indicating the location of a CD-SSB.
SCS: subcarrier spacing
SI-RNTI: System Information Radio-Network Temporary Identifier
Camp on: “Camp on” is the UE state in which the UE stays on a cell and is ready to initiate a potential dedicated service or to receive an ongoing broadcast service.
TB: Transport Block
RSA (RedCap standalone): RSA means a cell that supports only RedCap devices or services

In the present disclosure, the term “set/setting” may be replaced with “configure/configuration”, and both may be used interchangeably. Further, a conditional expression (e.g., “if”, “in a case”, or “when”) may be replaced by “based on that” or “in a state/status”. In addition, an operation or software/hardware (SW/HW) configuration of a user equipment (UE)/base station (BS) may be derived/understood based on satisfaction of a corresponding condition. When a process on a receiving (or transmitting) side may be derived/understood from a process on the transmitting (or receiving) side in signal transmission/reception between wireless communication devices (e.g., a BS and a UE), its description may be omitted. Signal determination/generation/encoding/transmission of the transmitting side, for example, may be understood as signal monitoring reception/decoding/determination of the receiving side. Further, when it is said that a UE performs (or does not perform) a specific operation, this may also be interpreted as that a BS expects/assumes (or does not expect/assume) that the UE performs the specific operation. When it is said that a BS performs (or does not perform) a specific operation, this may also be interpreted as that a UE expects/assumes (or does not expect/assume) that the BS performs the specific operation. In the following description, sections, embodiments, examples, options, methods, schemes, proposals and so on are distinguished from each other and indexed, for convenience of description, which does not mean that each of them necessarily constitutes an independent disclosure or that each of them should be implemented only individually. Unless explicitly contradicting each other, it may be derived/understood that at least some of the sections, embodiments, examples, options, methods, schemes, proposals and so on may be implemented in combination or may be omitted.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

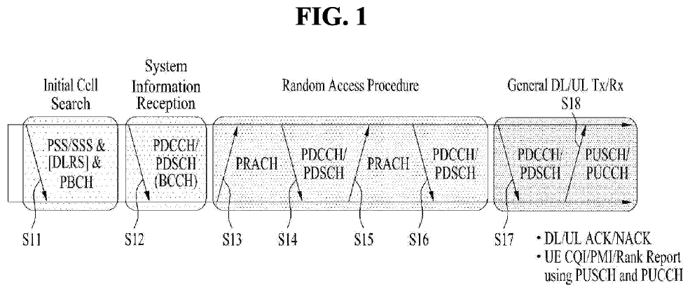

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

The SSB is composed of four consecutive OFDM symbols, each carrying the PSS, the PBCH, the SSS/PBCH, or the PBCH. Each of the PSS and the SSS includes one OFDM symbol by 127 subcarriers, and the PBCH includes three OFDM symbols by 576 subcarriers. The PBCH is encoded/decoded based on Polar codes, and modulation/demodulation is performed thereon according to quadrature phase shift keying (QPSK). The PBCH in the OFDM symbol consists of data resource elements (REs) to which a complex modulation value of the PBCH is mapped, and demodulation reference signal (DMRS) REs to which a DMRS for the PBCH is mapped. Three DMRS REs are configured for each RB in the OFDM symbol, and three data REs configured between DMRS REs.

The PSS may be used in detecting a cell ID within a cell ID group, and the SSS may be used in detecting a cell ID group. The PBCH may be used in detecting an SSB (time) index and a half-frame. There are 336 cell ID groups, and each cell ID group includes three cell IDs. Thus, there are a total of 1008 cell IDs.

SSBs are periodically transmitted with an SSB periodicity. A default SSB periodicity assumed by the UE in initial cell search is defined as 20 ms. After cell access, the SSB periodicity may be set to one of {5 ms, 10 ms, 20 ms, 40 ms, 80 ms, and 160 ms} by the network (e.g., BS). An SSB burst set may be configured at the beginning of the SSB periodicity. The SSB burst set may be set to a time window of 5 ms (i.e., half-frame), and the SSB may be repeatedly transmitted up to L times within the SS burst set. The maximum number of SSB transmissions L may be given depending carrier frequency bands as follows. One slot includes up to two SSBs
For frequency range up to 3 GHz, L=4
For frequency range from 3 GHz to 6 GHz, L=
For frequency range from 6 GHz to 52.6 GHz, L=64

The time-domain positions of candidate SSBs in the SS burst set may be defined depending on subcarrier spacings. The time-domain positions of the candidate SSBs are indexed from (SSB indices) 0 to L-1 in temporal order within the SSB burst set (i.e., half-frame).

Multiple SSBs may be transmitted within the frequency span of a carrier. Each SSB may not need to have a unique physical layer cell identifier, but different SSBs may have different physical layer cell identifiers.

The UE may acquire DL synchronization by detecting the SSB. The UE may identify the structure of the SSB burst set based on the detected SSB (time) index, and thus the UE may detect a symbol/slot/half-frame boundary. A frame/half-frame number to which the detected SSB belongs may be identified based on system frame number (SFN) information and half-frame indication information.

Specifically, the UE may obtain a 10-bit SFN for a frame to which a PBCH belongs from the PBCH. Then, the UE may obtain 1-bit half-frame indication information. For example, when the UE detects the PBCH in which the half-frame indication bit is set to 0, the UE may determine that an SSB to which the PBCH belongs is included in the first half-frame of the frame. When the UE detects the PBCH in which the half-frame indication bit is set to 1, the UE may determine that an SSB to which the PBCH belongs is included in the second half-frame of the frame. Finally, the UE may obtain the SSB index of the SSB to which the PBCH belongs based on a DMRS sequence and a PBCH payload carried by the PBCH.

After initial cell search, the UE may acquire more specific system information by receiving a physical downlink control channel (PDCCH) and receiving a physical downlink shared channel (PDSCH) based on information of the PDCCH in step S102.

System information (SI) is divided into a master information block (MIB) and a plurality of system information blocks (SIBs). The SI except for the MIB may be referred to as remaining minimum system information (RMSI). Details thereof will be described in the following.
The MIB includes information/parameters for monitoring a PDCCH scheduling a PDSCH carrying SIB1 (SystemInformationBlock1), and the MIB is transmitted by the BS over the PBCH of an SSB. For example, the UE may check based on the MIB whether there is a CORESET for a Type0-PDCCH common search space. The Type0-PDCCH common search space is a kind of PDCCH search space, which is used to transmit a PDCCH scheduling an SI message. If the Type0-PDCCH common search space exists, the UE may determine (1) a plurality of contiguous RBs and one or more consecutive symbols included in the CORESET and (ii) a PDCCH occasion (e.g., a time-domain location for PDCCH reception, based on information (e.g., pdcch-ConfigSIB1) in the MIB. If the Type0-PDCCH common search space does not exist, pdcch-ConfigSIB1 provides information on a frequency location at which the SSB/SIB1 exists and information on a frequency range where there are no SSB/SIB1.
SIB1 includes information related to availability and scheduling (e.g., transmission periodicity, SI-window size, etc.) of the remaining SIBs (hereinafter referred to as SIBx where x is an integer more than or equal to 2). For example, SIB1 may indicate whether SIBx is periodically broadcast or provided at the request of the UE in an on-demand manner. When SIBx is provided in an on-demand manner, SIB1 may include information necessary for the UE to send an SI request. SIB1 is transmitted over a PDSCH, and a PDCCH scheduling SIB1 is transmitted in the Type0-PDCCH common search space. That is, SIB1 is transmitted over the PDSCH indicated by the PDCCH.
SIBx is included in the SI message and transmitted on the PDSCH. Each SI message is transmitted within a periodically occurring time window (i.e., SI-window).

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

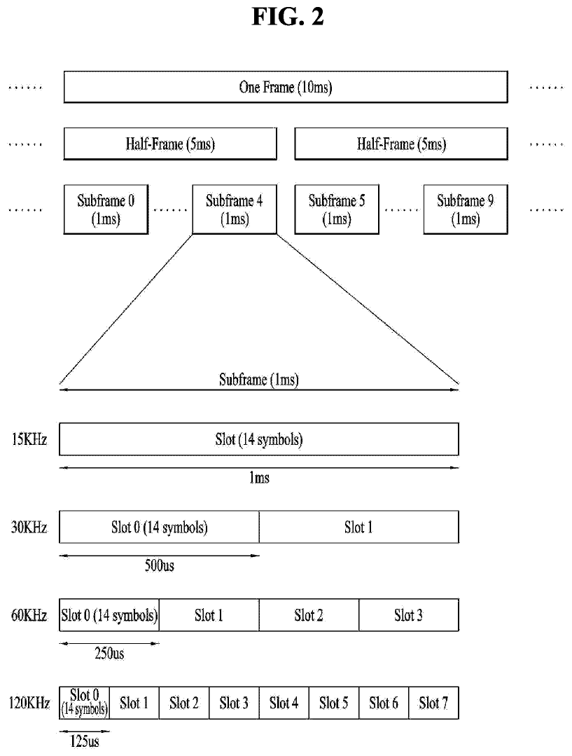

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

N^{slot}_{symb}: Number of symbols in a slot

N^{frame.u}ₛᵢₒₜ: Number of slots in a frame

N^{subframe.u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

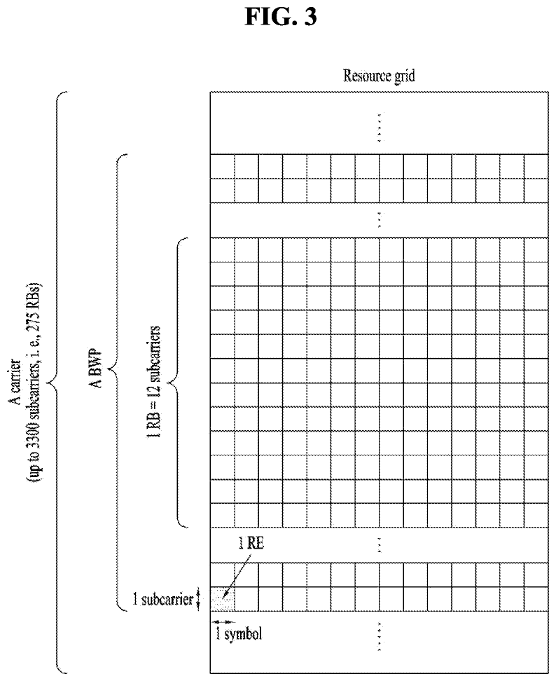

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

Bandwidth part (BWP)

The NR system may support up to 400 MHz for each carrier. The network may instruct the UE to operate only in a partial bandwidth rather than the whole bandwidth of such a wideband carrier. The partial bandwidth is referred to as a BWP. The BWP refers to a subset of contiguous common RBs defined for a numerology in the BWP of a carrier in the frequency domain, and one numerology (e.g., SCS, CP length, slot/mini-slot duration, etc.) may be configured.

Activation/deactivation of a DL/UL BWP or BWP switching may be performed according to network signaling and/or timers (e.g., L1 signaling corresponding to a physical layer control signal, a MAC control element corresponding to a MAC layer control signal, RRC signaling, etc.). While performing initial access or before setting up an RRC connection, the UE may not receive any DL/UL BWP configurations. A DL/UL BWP that the UE assumes in this situation is referred to as an initial active DL/UL BWP.

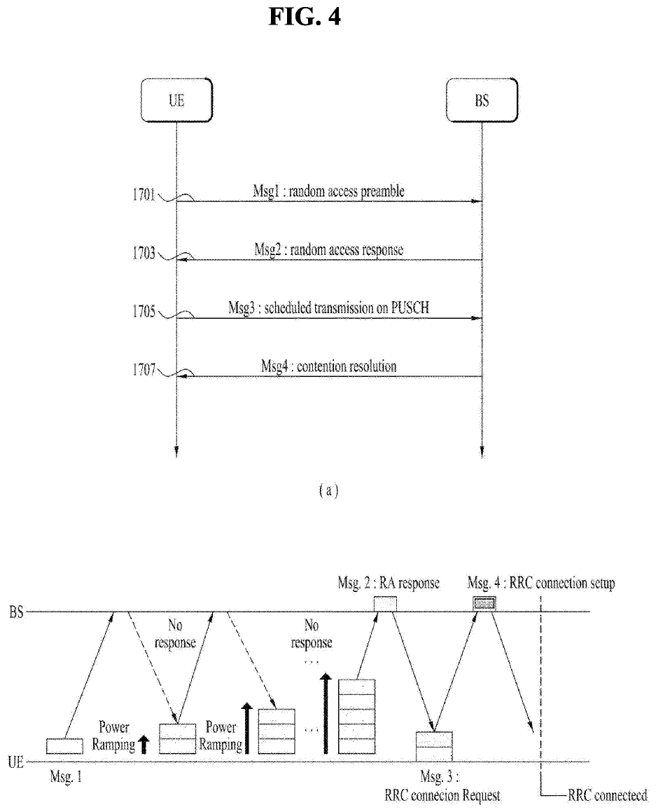

FIG. 4 illustrates an exemplary normal random access procedure. Specifically, FIG. 4 shows a contention-based random access procedure of the UE, which is performed in four steps.

First, the UE may transmit message 1 (Msg1) including a random access preamble on a PRACH (see 1701 of FIG. 4(a)).

Random access preamble sequences with different lengths may be supported. A long sequence length of 839 may be applied to SCSs of 1.25 and 5 kHz, and a short sequence length of 139 may be applied to SCSs of 15, 30, 60, and 120 kHz.

Multiple preamble formats may be defined by one or more RACH OFDM symbols and different CPs (and/or guard times). A RACH configuration for a cell may be included in SI about the cell and provided to the UE. The RACH configuration may include information on the SCS of the PRACH, available preambles, preamble formats, and so on. The RACH configuration may include information about association between SSBs and RACH (time-frequency) resources. The UE transmits a random access preamble on a RACH time-frequency resource associated with a detected or selected SSB.

The threshold of an SSB for RACH resource association may be configured by the network, and a RACH preamble may be transmitted or retransmitted based on an SSB where reference signal received power (RSRP), which is measured based on the SSB, satisfies the threshold. For example, the UE may select one SSB from among SSBs that satisfy the threshold and transmit or retransmit the RACH preamble based on a RACH resource associated with the selected SSB.

Upon receiving the random access preamble from the UE, the BS may transmit message 2 (Msg2) corresponding to a random access response (RAR) message to the UE (see 1703 of FIG. 4(a)). A PDCCH scheduling a PDSCH carrying the RAR may be CRC masked with a random access (RA) radio network temporary identifier (RNTI) (RA-RNTI) and then transmitted. Upon detecting the PDCCH masked by the RA-RNTI, the UE may obtain the RAR from the PDSCH scheduled by DCI carried by the PDCCH. The UE may check whether the RAR includes RAR information in response to the preamble transmitted by the UE, i.e., Msg1. The presence or absence of the RAR information in response to Msg1 transmitted by the UE may be determined depending on whether there is a random access preamble ID for the preamble transmitted by the UE. If there is no response to Msg1, the UE may retransmit the RACH preamble within a predetermined number of times while performing power ramping. The UE may calculate PRACH transmit power for retransmitting the preamble based on the most recent path loss and power ramping counter.

The RAR information transmitted on the PDSCH may include timing advance (TA) information for UL synchronization, an initial UL grant, and a temporary cell-RNTI (C-RNTI). The TA information may be used to control a UL signal transmission timing. The UE may transmit a UL signal over a UL shared channel as message 3 (Msg3) of the random access procedure based on the RAR information (see 1705 of FIG. 4(a)). Msg3 may include an RRC connection request and a UE identifier. In response to Msg3, the network may transmit message 4 (Msg4), which may be treated as a contention resolution message on DL (see 1707 of FIG. 4(a)). Upon receiving Msg4, the UE may enter the RRC_CONNECTED state.

On the other hand, a contention-free random access procedure may be performed when the UE is handed over to another cell or BS or when it is requested by the BS. In the contention-free random access procedure, a preamble to be used by the UE (hereinafter referred to as a dedicated random access preamble) is allocated by the BS. Information on the dedicated random access preamble may be included in an RRC message (e.g., handover command) or provided to the UE through a PDCCH order. When the random access procedure is initiated, the UE may transmit the dedicated random access preamble to the BS. When the UE receives an RAR from the BS, the random access procedure is completed.

As described above, a UL grant in the RAR may schedule PUSCH transmission to the UE. A PUSCH carrying initial UL transmission based on the UL grant in the RAR is referred to as an Msg3 PUSCH. The content of an RAR UL grant may start at the MSB and end at the LSB, and the content may be given as shown in Table 3.

TABLE 3

| | Numer |
|---|---|
| RAR UL grant field | of bits |
| Frequency hopping flag | 1 |
| Msg3 PUSCH frequency resource allocation | 12 |
| Msg3 PUSCH time resource allocation | 4 |
| Modulation and coding scheme (MCS) | 4 |
| Transmit power control (TPC) for Msg3 PUSCH | 3 |
| CSI request | 1 |

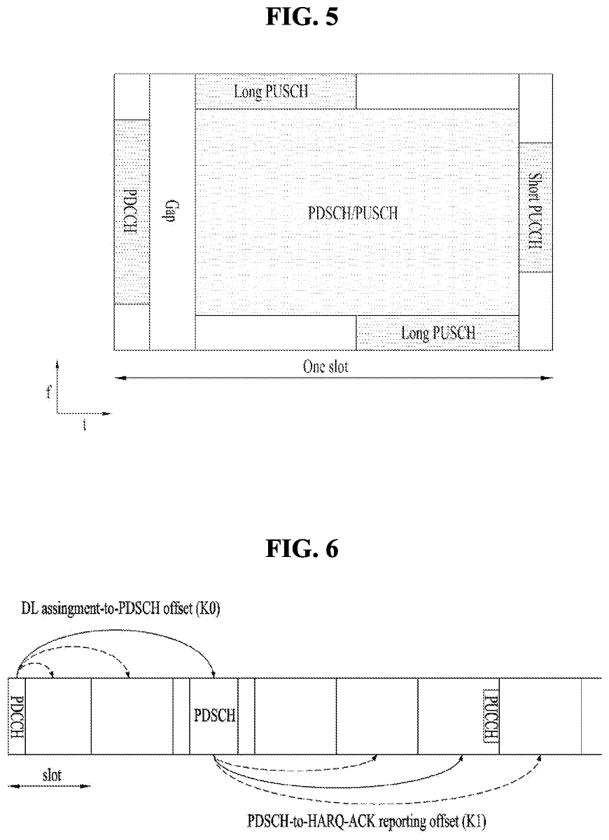

FIG. 5 illustrates exemplary mapping of physical channels in a slot. A PDCCH may be transmitted in a DL control region, and a PDSCH may be transmitted in a DL data region. A PUCCH may be transmitted in a UL control region, and a PUSCH may be transmitted in a UL data region. A guard period (GP) provides a time gap for transmission mode-to-reception mode switching or reception mode-to-transmission mode switching at a BS and a UE. Some symbol at the time of DL-to-UL switching in a subframe may be configured as a GP.

Each physical channel will be described below in greater detail.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH includes 1, 2, 4, 8, or 16 control channel elements (CCEs) according to its aggregation level (AL). A CCE is a logical allocation unit used to provide a PDCCH with a specific code rate according to a radio channel state. A CCE includes 6 resource element groups (REGs), each REG being defined by one OFDM symbol by one (P)RB. The PDCCH is transmitted in a control resource set (CORESET). A CORESET is defined as a set of REGs with a given numerology (e.g., an SCS, a CP length, and so on). A plurality of CORESETs for one UE may overlap with each other in the time/frequency domain. A CORESET may be configured by system information (e.g., a master information block (MIB)) or UE-specific higher-layer signaling (e.g., radio resource control (RRC) signaling). Specifically, the number of RBs and the number of symbols (3 at maximum) in the CORESET may be configured through higher-layer signaling.

For PDCCH reception/detection, the UE monitors PDCCH candidates. A PDCCH candidate is CCE(s) that the UE should monitor to detect a PDCCH. Each PDCCH candidate is defined as 1, 2, 4, 8, or 16 CCEs according to an AL. The monitoring includes (blind) decoding PDCCH candidates. A set of PDCCH candidates decoded by the UE are defined as a PDCCH search space (SS). An SS may be a common search space (CSS) or a UE-specific search space (USS). The UE may obtain DCI by monitoring PDCCH candidates in one or more SSs configured by an MIB or higher-layer signaling. Each CORESET is associated with one or more SSs, and each SS is associated with one CORESET. An SS may be defined based on the following parameters.
controlResourceSetId: A CORESET related to an SS.
monitoringSlotPeriodicityAndOffset: A PDCCH monitoring periodicity (in slots) and a PDCCH monitoring offset (in slots).
monitoringSymbolsWithinSlot: PDCCH monitoring symbols in a slot (e.g., the first symbol(s) of a CORESET).
nrofCandidates: The number of PDCCH candidates (one of 0, 1, 2, 3, 4, 5, 6, and 8) for each AL={1, 2, 4, 8, 16}.

*An occasion (e.g., time/frequency resources) in which the UE is to monitor PDCCH candidates is defined as a PDCCH (monitoring) occasion. One or more PDCCH (monitoring) occasions may be configured in a slot.

Table 4 shows the characteristics of each SS.

TABLE 4

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging Decoding |
| PDCCH | | | |
| Type3- | Common | INT-RNTI, SFI-RNTI, | |
| PDCCH | | TPC-PUSCH-RNTI, | |
| | | TPC-PUCCH-RNTI, | |
| | | TPC-SRS-RNTI, | |
| | | C-RNTI, MCS-C-RNTI, | |
| | | or CS-RNTI(s) | |
| | UE | C-RNTI, or MCS-C-RNTI, | User specific |
| | Specific | or CS-RNTI(s) | PDSCH decoding |

Table 5 shows DCI formats transmitted on the PDCCH.

TABLE 5

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping may be performed on a codeword basis, and modulation symbols generated from each codeword may be mapped to one or more layers. Each layer together with a demodulation reference signal (DMRS) is mapped to resources, and an OFDM symbol signal is generated from the mapped layer with the DMRS and transmitted through a corresponding antenna port.

The PUCCH delivers uplink control information (UCI). The UCI includes the following information.
SR (Scheduling Request): Information used to request UL-SCH resources.
HARQ (Hybrid Automatic Repeat reQuest)-ACK (Acknowledgement): A response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.
CSI (Channel State Information): Feedback information for a DL channel Multiple input multiple output (MIMO)-related feedback information includes an RI and a PMI.

The PUSCH delivers UL data (e.g., UL-shared channel transport block (UL-SCH TB)) and/or UCI based on a CP-OFDM waveform or a DFT-s-OFDM waveform. When the PUSCH is transmitted in the DFT-s-OFDM waveform, the UE transmits the PUSCH by transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. A PUSCH transmission may be dynamically scheduled by a UL grant in DCI, or semi-statically scheduled by higher-layer (e.g., RRC) signaling (and/or Layer 1 (L1) signaling such as a PDCCH) (configured scheduling or configured grant). The PUSCH transmission may be performed in a codebook-based or non-codebook-based manner.

Reduced Capability (RedCap) Device

Recently, the importance and interest in use case areas over mMTC and eMBB or over mMTC and URLLC are increasing in addition to 5G main use cases (mMTC, eMBB, and URLLC). Accordingly, the need for a UE to efficiently support these use cases in terms of device cost, power consumption, form factor, etc. is also increasing. In the present disclosure, such a UE is called a (NR) reduced capability UE/device or simply, a (NR) RedCap UE/device. In addition, a normal NR UE that supports all or some of the 5G main use cases is referred to as an NR (normal) UE/device to distinguish it from the RedCap device. Specifically, the NR UE may be a UE equipped with all 5G key capabilities (peak data rate, user experienced data rate, latency, mobility, connection density, energy efficiency, spectrum efficiency, area traffic efficiency, etc.) defined by IMT-2020, and the RedCap UE may be a UE of which some capabilities are intentionally reduced to achieve device cost, power consumption, and small form factors.

In this document, 5G use case areas spanning over mMTC and eMBB or over mMTC and URLLC, which are target use cases of the RedCap device, are referred to as RedCap use cases for convenience of description.

The RedCap use cases may not be supported by low power wireless area (LPWA) UEs (e.g., LTE-M, NB-IoT, etc.) in terms of bit rates, latency, etc. However, the RedCap use cases may be functionally supported by NR UEs, but it may be inefficient in terms of UE manufacturing cost, form factors, battery life, and the like. If the above use case area are supported by the RedCap UE having characteristics such as low cost, low power, and small form factors in the 5G network, UE manufacturing and maintenance cost may be reduced

The RedCap use cases have significantly diverse requirements in terms of UE complexity, target bit rates, latency, power consumption, etc. In the present disclosure, the requirements that the RedCap UE needs to satisfy are referred to as RedCap requirements. The RedCap requirements may be divided into generic requirements that are commonly applied to all RedCap use cases and use case specific requirements that are applied only to some use case(s). Table 6 illustrates generic and use case specific requirements for three representative RedCap use cases in brief.

TABLE 6

| | Com- | Form | Bit rate | Latency | | |
|---|---|---|---|---|---|---|
| Use cases | plexity | factor | (Mbps) | (ms) | Mobility | Battery |
| Industrial | Very | Very | A few | Tens of/ | Stationary | Years |
| Wireless | low | small | | A few ¹⁾ | | |
| Sensor | | | | | | |
| Video | Low | Small | A few/ | Hundreds | Stationary | |
| Surveillance | | | Tens of | of | | |
| Wearables | Low | Small | Tens of | | Mobile | Weeks |

The features supported by the UE/BS to satisfy the RedCap requirements may be roughly divided into; (i) complexity reduction; (ii) power saving; and (iii) coverage recovery/enhancement. (i) Complexity reduction may be related to a reduced number of UE RX/TX antennas, a UE bandwidth (BW) reduction, half-duplex FDD, a relaxed UE processing time, and/or a relaxed UE processing capability. (ii) Power Saving may be related to reduced PDCCH monitoring by a smaller numbers of BDs and CCE limits, extended DRX for RRC inactive and/or idle, and RRM relaxation for stationary devices.

The following two cases are all considered in the present disclosure.

Case A) RedCap use cases are supported by one type of UE (single device type case).

Case B) RedCap use cases are supported by multiple types of UEs (multi-device type case).

For Case A), the RedCap UE may be a UE that satisfies all of the RedCap requirements, that is, all of the generic and use case specific requirements. In addition, the RedCap UE may be a UE supporting all RedCap use cases. In this case, since various requirements need to be satisfied at the same time, there may be a factor of cost increase due to an increase in UE complexity. However, cost reduction may also be expected by mass production according to use case expansion. For Case B), considering diverse requirements of the RedCap use cases, a UE type may be defined and supported for each RedCap use case. In this case, all the generic requirements need to be satisfied in common. Each device type defined for each use case is called a RedCap device type. For Case B), use cases similar in terms of requirements are grouped and supported by one type of UE. Each RedCap device types may support a predefined part of the RedCap UE features or a specific combination thereof. When multiple RedCap device types are defined to support the RedCap use cases, there is an advantage that specific RedCap use case(s) are supported by a RedCap UE optimized in terms of cost, power consumption, etc. For example, the IWS use case may be supported by a very small, inexpensive, and power efficient UE.

In the present disclosure, a reduced capability may include reduced/low complexity/cost, reduced BW, and so on.

RedCap Device Type Classification and Report

The RedCap UE may need to report information on its device type to the BS to support RedCap UE operations different from those of the NR UE.

For example, device types may be classified according to the following criteria.

*Classification criterion 1: RedCap device types may be classified based on one of the main requirements. The main requirements that may act as a criterion for classification may include, for example, a supported max data rate (peak bit rate), latency, mobility (stationary/fixed, portable, mobile, etc.), battery lifetime, complexity, coverage, etc. UE feature(s) that need to be supported mandatory or may be selectively supported for each classified RedCap device type (or combinations of the UE features) may be defined in specifications.

*Classification criterion 2: Classification may be performed based on UE feature(s) that need to be supported or may be selectively supported (or combinations of the UE features). UE feature(s) (or combinations thereof) predefined in specifications for each RedCap device type may be referred to as a feature set, and a feature set that needs to be supported for each device type may be referred to as a mandatory feature set for the corresponding device type or a mandatory feature set for defining the device type. RedCap use cases may be related to UE types supporting different feature sets.

*Classification criterion 3: RedCap device types may be classified based on a combination of capability parameter(s). The capability parameters may be parameters for determining RedCap requirements. For example, capability parameters for determining a RedCap device type may be a BW supported by the UE, a modulation order, the number of MIMO layers, and the like, which are to determine a max data rate requirement supported by the UE. The values of parameters may be a list of actually supportable values or a maximum value among supported values. The combination of capability parameters that determine a RedCap device type may be referred to as a capability parameter set of the corresponding device type. The RedCap device type may be defined, for example, by sorting capability parameter set value(s) in ascending order (or descending order) of supported max data rates. The BW capability of the RedCap UE, that is, the UE maximum BW, may be determined as the minimum BW that satisfies the bit rate required by a target use case.

*Classification criterion 4: Considering that the BW capability of the RedCap UE is determined by the required bit rate of each use case, RedCap device types may be classified based on UE BW capabilities. The BW capability for determining the RedCap device type may be, for example, a supported BW (NRB), which is obtained by representing a (max) UE channel BW or (max) UE transmission BW at the RB level. Alternatively, it may be a minimum UE channel BW or a minimum UE transmission BW. Specifically, the following classification may be allowed.
Classification Method 4-1) Classification is performed based on the maximum BW, and an actual BW for data transmission/reception is configured and used (<=maximum BW).
Classification Method 4-2) Classification is performed based on the minimum BW, and an actual BW for data transmission/reception is configured and used (>=minimum BW)
Classification Method 4-3) one or more supportable BWs (set) are defined for each device type, and an actual BW for data transmission/reception is configured and used within the corresponding BWs (set).

For Classification Methods 4-1/4-2/4-3, the maximum BW may be set less than a NR BW (e.g., 20 MHz), and the minimum BW may be set to more than or equal to an SSB BW (e.g., 5 MHz for a 15 kHz SSB).

CORESET#0/SS Configuration for Cell Access of RedCap UE

According to an embodiment of the present disclosure, (additional) cell access information for the RedCap UE may be provided to support the RedCap device to access a NR cell. In addition, the present disclosure proposes a method of configuring CORESET#0 and a Type0-PDCCH CSS set for scheduling the (additional) cell access information.

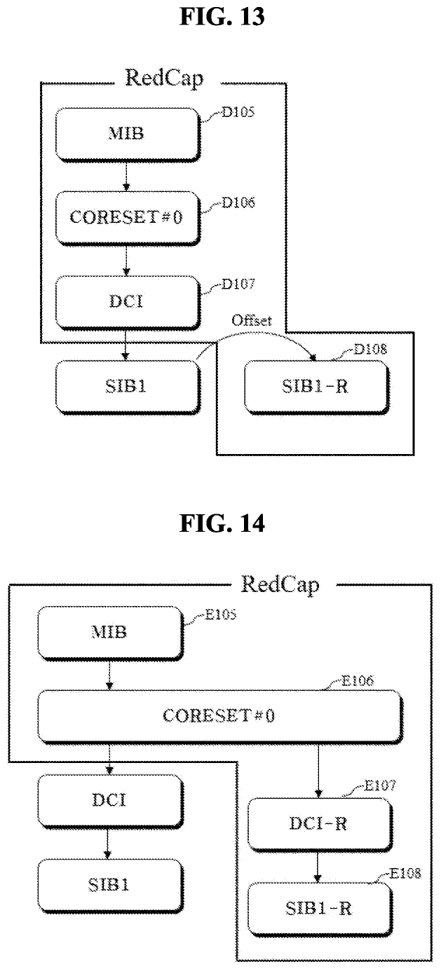

FIG. 9 is a flowchart of a CORESET#0/SS configuration method to which the present disclosure is applicable.

Referring to FIG. 9, the BS may transmit a PBCH to the UE, and the UE may receive the PBCH from the BS (SH202). CORESET#0 (and/or CORESET#0-R) related information and/or MO (and/or MO-R) related information may be configured and transmitted/received over the PBCH according to the method proposed in the present disclosure.

The BS may transmit SIB1 scheduling information to the UE in CORESET#0, and the UE may receive the SIB1 scheduling information from the BS in CORESET#0 (SH204). The SIB1 scheduling information may be configured and transmitted/received according to the method proposed in the present disclosure.

The BS may transmit SIB1 to the UE based on the SIB1 scheduling information, and the UE may receive SIB1 from the BS based on the SIB1 scheduling information (SH206). According to the method proposed in the present disclosure, SIB1 may include NR SIB1 (or legacy SIB1) and/or SIB1-R.

The CORESET#0/SS configuration method proposed in the present disclosure may be applied to the PBCH transmission/reception process (SH202), the SIB1 scheduling information transmission/reception process (SH204), and/or the SIB1 transmission/reception process (SH206).

### 8 Configuration Example 1] Transmission of Cell Access Information for RedCap UE in CORESET#0

The network may use a conventional PDSCH for SIB1 transmission (hereinafter referred to as an SIB1 PDSCH) to transmit (additional) cell access information for the RedCap UE. The (additional) cell access information for the RedCap UE may be included in the SIB1 PDSCH for the NR UE. According to this method, the network may generate SIB1 for the NR UE and the (additional) cell access information for the RedCap UE as one TB and transmit the TB over the SIB1 PDSCH. SIB1 scheduling information may be transmitted in the same way as in legacy NR. For example, the network may configure CORESET#0 to transmit the SIB1 scheduling information and transmit CORESET#0 configuration information on a PBCH.

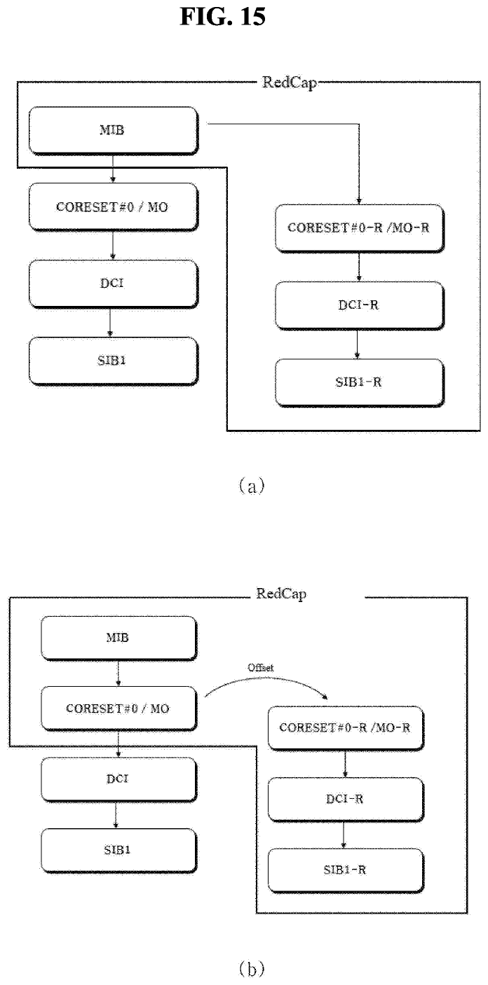

FIG. 10 is a flowchart illustrating the corresponding method from the perspective of the RedCap UE. The UE may receive an MIB over a PBCH in an SSB (A105). The UE may obtain information on CORESET #0 (and related SS configurations) from the MIB and monitor PDCCH candidates in CORESET #0 (A106). The UE may receive DCI (A107) and receive a TB scheduled by the DCI (A108). The TB may include both SIB1 and SIB1-R.

For example, this method may be limitedly applied only when the (SIB1 PDSCH) payload size after adding the cell access information for the RedCap UE does not exceed a maximum SIB1 payload size limit (e.g., 2976 bits) defined in NR.

For example, when the (SIB1 PDSCH) payload size exceeds the maximum SIB1 payload size defined in NR due to addition of the cell access information for the RedCap UE, or when the amount of cell access information added for the RedCap UE is above a threshold from the point of view of the system even if the payload size does not exceed the maximum SIB1 payload size, the network may generate a TB carrying (additional) cell access information for the RedCap UE separately from a TB carrying SIB1 for the NR UE and then transmit the TB over a different PDSCH. For convenience, the (additional) cell access information for the RedCap UE transmitted over the different TB/PDSCH is referred to as SIB1-R, and SIB1 for the normal NR UE is simply referred to as SIB1.

For example, the RedCap UE may need to (sequentially) receive both the (NR UE) SIB and SIB1-R for cell access. As an example of sequential reception, the RedCap UE may check suitability for camping on a corresponding cell by reading SIB1. Then, the RedCap UE may perform paging monitoring and initial access by acquiring additional RACH configuration and paging information from SIB1-R after camping on the cell.

FIG. 11 is a flowchart illustrating the corresponding method from the perspective of the RedCap UE. The UE may receive an MIB over a PBCH in an SSB (B105). The UE may obtain information on CORESET #0 (and related SS configurations) from the MIB and monitor PDCCH candidates in CORESET #0 (B106). The UE may receive DCI (AB07) (B107?) and receive a TB including SIB1 (B108). The UE may receive a TB including SIB-R (B109). Scheduling of the SIB-R will be described later.

[Single DCI Scheme—SIB1-R is transmitted on separate PDSCH, but both SIB1 and SIB1-R are scheduled by SIB1 scheduling DCI]

In an example in which the BS configures SIB1 and SIB1-R with different TBs and transmits the TBs over different PDSCHs, SIB1-R scheduling information and SIB1 scheduling information may be transmitted in the same DCI. For example, a PDSCH carrying SIB1 and PDSCH(s) carrying SIB1-R, which are TDMed or FDMed with the PDSCH, may be scheduled by a single DCI. The PDSCH carrying SIB1 and the PDSCH(s) carrying SIB1-R may be TDMed or FDMed with each other.

FIG. 12 is a flowchart illustrating the corresponding method from the perspective of the RedCap UE. The UE may receive an MIB over a PBCH in an SSB (C105). The UE may obtain information on CORESET #0 (and related SS configurations) from the MIB and monitor PDCCH candidates in CORESET #0 (C106). The UE may receive DCI (C107) and receive SIB-R scheduled by the DCI (C108). Whether the RedCap UE additionally needs to receive an SIB may vary depending on embodiments.

For example, SIB1 scheduling DCI may be configured to schedules an SIB1 PDSCH as in the prior art, but an SIB1-R PDSCH may be configured to have an offset (e.g., a time offset and/or a frequency offset) from the SIB1 PDSCH. In this case, the time or frequency offset may have a predetermined value (e.g., a preconfigured value where no signaling is required), or the time or frequency offset may be transmitted through specific field/bits (e.g., reserved field/bits) of the SIB1 scheduling DCI. FIG. 13 is a flowchart illustrating the corresponding method from the perspective of the RedCap UE. The UE may receive an MIB over a PBCH in an SSB (D105). The UE may obtain information on CORESET #0 (and related SS configurations) from the MIB and monitor PDCCH candidates in CORESET #0 (D106). The UE may receive DCI (D107) and receive an SIB-R PDSCH by applying an offset to an SIB PDSCH scheduled by the DCI (D108). Whether the RedCap UE additionally needs to receive the SIB PDSCH may vary depending on embodiments.

For example, SIB1-R scheduling information (or at least part of the SIB1-R scheduling information) may be transmitted through a specific field/bit (e.g., reserved field/bit) of the SIB1 scheduling DCI.

When SIB1 and SIB1-R scheduling information are transmitted in a single DCI, the DCI reception burden of the RedCap UE may be reduced, thereby achieving UE power saving and latency reduction.

For example, the single DCI may be DCI format 1_0 with a CRC scrambled by an SI-RNTI transmitted in CORESET#0.

[SIB1-R is transmitted over separate PDSCH, and SIB1-R is scheduled by separate DCI in CORESET#0]

The network may transmit SIB1-R over a different PDSCH (i.e., SIB1-R PDSCH) from an SIB1 PDSCH. In addition, the network may transmit SIB1-R scheduling DCI in CORESET#0, independently of SIB1 scheduling DCI.

For example, to distinguish the SIB1-R scheduling DCI from the SIB1 scheduling DCI, it is possible to use a DCI size/format different from conventional DCI format 1_0 having a CRC scrambled by an SI-RNTI and used for the SIB1 scheduling DCI.

For example, if the same DCI size as that of the SIB1 scheduling DCI needs to be used for reasons such as the blind detection (BD) capability of the RedCap UE, the DCIs may be identified by RNTIs. That is, to distinguish from an SI-RNTI for SI reception, a separate RNTI (i.e., SI-R-RNTI) may be defined/allocated for SI reception of the RedCap UE.

For example, if the same DCI size and the same RNTI (SI-RNTI) are used for SIB1-R scheduling DCI and SIB1 scheduling DCI (due to insufficient available RNTIs, etc.), the SIB1-R scheduling DCI and the SIB1 scheduling DCI may be distinguished by unused states of a DCI field (e.g., unused state of an MCS field).

In addition, the SIB1-R scheduling DCI and the SIB1 scheduling DCI may be distinguished by using/transforming (e.g., flipping) an 8-bit distributed CRC (i.e., PDCCH CRC) for early termination of a BD-based DCI detection process

When distributed CRC transformation (e.g., flipping) is applied to DCI format 1_0 with a CRC scrambled by an SI-RNTI, it may be advantageous to apply the same distributed CRC transformation even when the same DCI format is transmitted based on a different (type) RNTI (e.g., C-RNTI) to prevent an increase in the BD burden of the UE.

FIG. 14 is a flowchart illustrating the corresponding method from the perspective of the RedCap UE. The UE may receive an MIB over a PBCH in an SSB (E105). The UE may obtain information on CORESET #0 (and related SS configurations) from the MIB and monitor PDCCH candidates in CORESET #0 (E106). The UE may receive DCI-R (E107) and receive an SIB-R scheduled by the DCI-R (E108). Whether the RedCap UE additionally needs to receive DCI and SIB1 may vary depending on embodiments.

### [Configuration Example 2] Transmission of Cell Access Information for RedCap UE in CORESET#0-R (CORESET#0 Dedicated to RedCap UE)

A method of configuring separate CORESET#0 for the RedCap UE and transmitting SIB1-R scheduling DCI in the corresponding CORESET may be used. This method may be used when NR CORESET#0 is incapable of being configured within a RedCap BW, for example, when CORESET#0 BW>RedCap BW. Alternatively, the method may be limitedly applied in the following cases.

The case in which NR CORESET#0 is incapable of being configured within the RedCap BW may include: a case in which CORESET#0 BW may not be set less than or equal to the RedCap BW due to a problem in the UE capacity of a corresponding NR cell (including the RedCap UE) or a problem that the CCE AL of a control channel may not be sufficiently secured; and a case in which a 5-MHz NR-Light UE needs to be supported in an FR1 30-kHz SSB frequency band.

[Determination of CORESET#0-R and MO-R Locations]

The BS may instruct the UE to receive SIB1-R including (part of) cell access information. The SIB1-R reception indication may be transmitted in a part of a PBCH payload (see FIG. 15(a) and/or 15(b)). The BS may additionally transmit CORESET#0-R configuration information and/or MO-R information for the SIB1-R reception while indicating the SIB1-R reception.

For example, the CORESET#0-R configuration information and/or MO-R information for the SIB1-R reception may mean that the UE needs to receive the (part of) cell access information in SIB1-R.

For example, if the UE has no CORESET#0-R configuration information and/or no MO-R information (e.g., a monitoring occasion related to the corresponding search space set configuration) to receive SIB1-R over a PBCH, the UE may assume that there is no SIB1-R information in the corresponding cell or the RedCap UE is not supported.

[MO-R Location]

While obtaining CORESET#0-R configuration information and/or MO-R information for SIB1-R reception, the RedCap UE may determine the location of the MO-R based on the location of an MO or SSB for the NR UE. For example, the RedCap UE may determine the starting point (e.g., starting slot) of the MO-R as a relative location (e.g., slot or symbol offset) from the (starting or ending slot of) the SSB or MO.

The location of the MO may be indicated by the PBCH. Information on the relative location (e.g., slot/symbol offset) of the MO-R may be predefined or transmitted in part of a PBCH payload. The part of the PBCH payload may be unused/reserved bit(s) among PBCH bit(s) generated at the physical layer (L1) or spare bit(s) of an MIB generated at the higher layer. The bit(s) generated at L1 may be, for example, signaled by an initialization value of a DMRS sequence used for PBCH reception.

[CORESET#0-R Location]

Similarly to determining the location of the MO-R described above, the location of CORESET#0-R may also be determined relative to the location of CORESET#0. Information on a time/frequency offset for determining the relative location may be predefined or transmitted in part of a PBCH payload.

For example, considering the maximum BW of the RedCap UE, only a part of CORESET#0 may be set to CORESET#0-R so that a CORESET#0-R BW is less than or equal to the maximum BW of the RedCap UE. The difference between the number of RBs included in CORESET#0 and the number of RBs included in CORESET#0-R may be provided as an offset by a PBCH (e.g., how much the CORESET#0 BW is reduced to determine the BW of CORESET#0-R from the perspective of the RedCap UE). According to this method, when the CORESET#0 BW is set to be greater than the maximum BW of the RedCap UE, several highest RB(s) or lowest RB(s) may be punctured in the CORESET#0 BW and then used in order to set CORESET#0-R less than or equal to the maximum BW of the RedCap UE. The number of RBs to be punctured may be predefined or transmitted through PBCH signaling.

Example) Determination of CORESET#0-R position and MO-R position

*Example E1) CORESET#0-R configuration information and/or MO-R information is transmitted in part of a PBCH payload.
For FR1, if a total of three or four bits (two spare bits in an MIB and one or two unused/reserved bit(s) in a PBCH DMRS sequence) are available, a limited configuration (e.g., table format) may be allowed with the three or four bits.
Information on the relative locations of the MO-R and CORESET#0-R may be transmitted according to the above-described method.
The CORESET#0-R configuration information and/or MO-R information may be jointly encoded with information indicating whether the cell supports RedCap.

*Example E2) Whether RedCap is supported or whether SIB1-R exists is indicated in part of a PBCH payload, and the configuration (e.g., time/frequency location) of an MO-R and CORESET#0-R is determined according to a predefined rule.
{SSB/CORESET#0-NL multiplex pattern, BW, number of symbols, RB offset} may be predefined.
The information on the relative locations of the MO-R and CORESET#0-R can be predefined.

*Example E3) Whether RedCap is supported or whether SIB1-R exists is indicated in part of a PBCH payload, and CORESET#0-R configuration information and/or MO-R information is transmitted over a separate signal/channel (i.e., 2-step signaling), where a message transmitted over the separate signal/channel is called an MIB-R for convenience.
The MIB-R may be transmitted over a signal/channel different from a PBCH carrying the legacy MIB. In this case, scheduling information for the MIB-R may be transmitted in (part of) the PBCH payload (similarly to Example E1) or determined according to a predefined rule (similarly to Example E2).

For the above examples, some parameter(s) (e.g., slot offset, RB offset, etc.) in CORESET#0-R configuration information and/or MO-R information for SIB1-R reception may be configurable parameter(s). The network may transmit the corresponding configurable parameter(s) in part of the PBCH payload. In this case, parameters other than the parameters indicated by the PBCH may be predefined.

When the above-described methods are applied, the RedCap UE may obtain SIB1-R from CORESET#0-R/MO-R as follows.

*PBCH payload reception (including MIB) ∵SIB-R reception (Example E1 or E2); or

*PBCH payload reception (including MIB)—>MIB-R reception—>SIB-R reception (Example E3).

[Implicit Indication—Method for UE to Determine Whether CORESET#0-R/MO-R is Used]

CORESET#0-R may be activated only when a CORESET#0 BW is out of a BW range supported by the RedCap UE. For example, if the frequency-domain size (e.g., the number of RBs) of CORESET#0 exceeds the maximum BW supported by the RedCap UE, CORESET#0-R may be activated. Alternatively, if CORESET#0 is not located at frequencies that the RedCap UE is capable of monitoring, CORESET#0-R may be activated.

The activation of CORESET#0-R may mean that the RedCap UE needs to receive cell access information in CORESET#0-R.

The BW supported by the RedCap UE may be determined by the minimum BW and/or the maximum BW. In a cell supporting RedCap UE, if a CORESET#0 BW is less than or equal to the RedCap maximum BW and more than or equal to the RedCap minimum BW, the RedCap UE may receive SIB1(-R) in CORESET#0. If the CORESET#0 BW is more than the RedCap maximum BW or less than the RedCap minimum BW, the RedCap UE may receive SIB1-R in CORESET#0-R.

When the minimum BW and/or maximum BW varies for each RedCap device type, the BW supported by the corresponding UE type may vary. Therefore, since CORESET#0-R activation may vary for each RedCap device type, CORESET#0 for acquisition of cell access information may vary for each RedCap device type. For example, specific RedCap device type(s) may obtain cell access information by receiving SIB1(-R) in CORESET#0, and other RedCap device type(s) may obtain cell access information by receiving SIB1-R in CORESET#0-R. This method may be applied to each RedCap device type as follows.

### Example

*For Classification Method 4-1), if the CORESET#0 BW configured by the BS is greater than the maximum BW of the RedCap device (type), CORESET#0-R may be activated

*For Classification Method 4-2), if the CORESET#0 BW configured by the BS is less than the minimum BW of the RedCap device (type), CORESET#0-R may be activated.

*For Classification Method 4-3), the BS may set the CORESET#0 BW to one (e.g., the maximum value) of BW values commonly supported by RedCap UEs (e.g., the maximum value), and the UE may activate CORESET#0-R if the CORESET#0 BW is not included in (a range of) BW value(s) supported by the UE.

In the above example, a case in which the BS is incapable of setting the CORESET#0 BW less than or equal to a specific value may include a case in which the BS is incapable of setting the CORESET#0 BW less than or equal to the specific value for reasons such as a problem in the UE capacity of a corresponding NR cell (including the RedCap UE) or a problem that the CCE AL of a control channel may not be sufficiently secured;

[Signaling Overhead Reduction Method]

Since the PBCH transmission payload is quite limited and future proofing also needs to be considered, it may be desirable to refrain from using reserved/spare fields/bits in the PBCH as much as possible. To minimize the use of reserved/spare fields/bits and reduce signaling overhead, a method of limiting/determining a CORESET#0(-R) BW in association with a RedCap BW (maximum or minimum BW) and/or an SSB BW may be considered.

For example, only CORESET#0 having a BW less than or equal to the maximum BW of the RedCap device (type) among CORESET#0 BWs supported by the corresponding cell may be configured to support the RedCap device. If separate CORESET#0 configuration/signaling is required for the RedCap device (type), it may be expected that as the number or combination of CORESET#0s supporting the RedCap device decreases, separate CORESET#0 configuration/signaling bits for the RedCap device (type) decrease.

*Limitation of CORESET#0(-R) BW by RedCap maximum BW
Example) Only (N_{c.M}) CORESET#0(-R)(s) having the largest BW among CORESET#0(-R)(s) having a BW less than (or less than or equal to) the RedCap maximum BW may be configured to support RedCap. The network may signal CORESET#0(-R)(s) supporting RedCap according to one of the methods described above.

*Limitation of CORESET#0(-R) by SSB BW (N_{c,s} CORESET#0(-R) BWs may be selected for each SSB)
Example) Only (N_{c,s}) CORESET#0(-R)(s) having the smallest BW among CORESET#0(-R)(s) with a BW more than (or more than or equal to) an SSB BW may be configured to support RedCap. The network may signal CORESET#0(-R)(s) supporting RedCap according to one of the methods described above.

For N_{c,s}=1, it may be considered that only 24-PRB CORESET#0(-R) is supported for an SSB of 15 kHz and only 48-PRB CORESET#0(-R) is supported for an SSB of 30 kHz SSB. However, the present disclosure is not limited thereto.

### [Configuration Example 31 PDCCH-Less SIB1-R is Transmitted

When PDCCH repetition is required for coverage recovery/enhancement (recovery/enhancement) of the RedCap UE, the network may transmit SIB1-R over a PDSCH with no PDCCH, that is, with no CORESET#0-R configuration, for power saving and/or latency reduction of the RedCap UE. For example, this method may be applied when it is not easy to configure CORESET#0(-R) with a BW less than or equal to the RedCap UE maximum BW or when SIB1-R needs to be transmitted over a PDSCH different from that of an SIB. Scheduling information for an SIB1-R PDSCH may be transmitted in part of a PBCH payload or may be determined according to a predefined rule. For example, the scheduling information for the SIB1-R PDSCH may be transmitted according to Example E1/E2/E3. Alternatively, a plurality of candidate scheduling parameter sets are predefined, and the candidate scheduling parameter sets may be selected and indicated based on indexing over the PBCH.

When PDCCH-less SIB1-R is transmitted, the RedCap UE may obtain cell access information as follows.

*PBCH payload reception (including MIB) ∵SIB1-R PDSCH reception (Example E-1 or E-2); or

*PBCH payload reception (including MIB) ∵MIB-R reception ∵SIB1-R PDSCH reception (Example E-3).

Referring again to FIG. 9, an exemplary initial cell access procedure of the UE will be described based on the above description.

The UE may receive a PBCH signal in an SSB (SH202). The UE may receive SIB1-scheduling information in a first CORESET based on the PBCH signal (SH202). The UE may receive SIB1 over a PDSCH (SH206).

The UE may be a second type of UE with reduced capability to support a maximum BW smaller than a first type of UE among different types of UEs supported in a 3GPP-based wireless communication system.

Even though the PBCH signal received by the UE is configured the same as a PBCH signal received by the first type of UE, SIB1 received by the UE may include a second type of SIB1 different from a first type of SIB1 received by the first type of UE.

The SIB1-scheduling information may include both scheduling information for the first type of SIB1 and scheduling information for the second type of SIB1.

Even though the UE receives the same SIB1-scheduling information as the first type of UE, the UE may receive the second type of SIB1 that is not received by the first type of UE.

The SIB1-scheduling information may be DCI received over a PDCCH.

SIB1-scheduling information received by the first type of UE and SIB1-scheduling information received by the second type of UE may be different in at least one of a DCI size, a related RNTI, or CRC masking. The first CORESET may be related to both the SIB1-scheduling information received by the first type of UE and the SIB1-scheduling information received by the second type of UE.

The first CORESET may be a part of a CORESET monitored by the first type of UE. Alternatively, the first CORESET may be obtained by applying a specific time offset or a specific frequency offset to a CORESET monitored by the first type of UE.

The UE may receive the second type of SIB1 at a location obtained by applying a specific time offset or a specific frequency offset to a location of the first type of SIB1.

The BS may support both a first type of UE and a second type of UE with reduced capability to support a smaller maximum BW than the first type of UE.

The BS may transmit a same PBCH signal commonly to the first type of UE and the second type of UE. The BS may transmit to the second type of UE a second type of SIB1 different from a first type of SIB1 for the first type of UE.

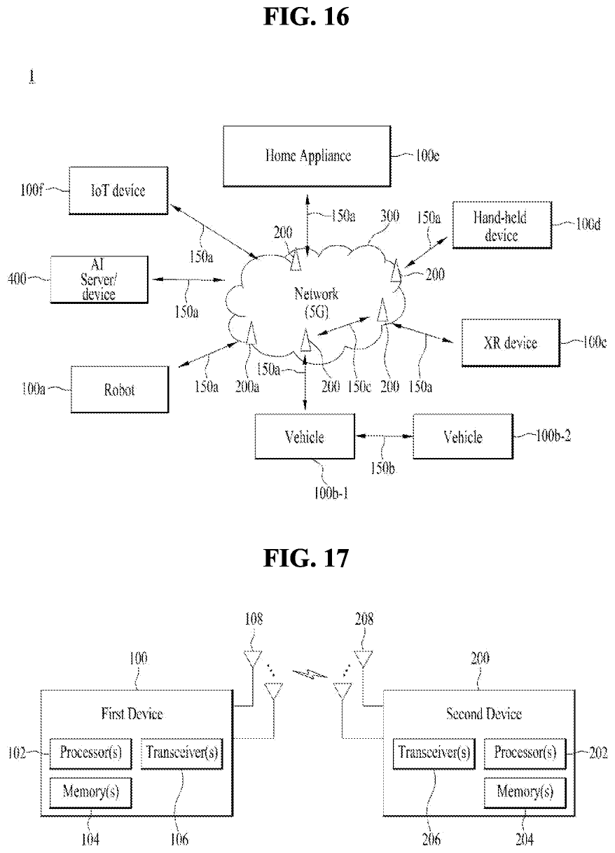

FIG. 16 illustrates a communication system 1 applied to the present disclosure.

Referring to FIG. 16, a communication system 1 includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BS s/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 17 illustrates wireless devices applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

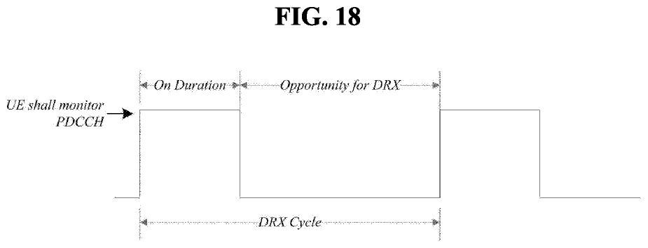

FIG. 18 is a diagram illustrating a DRX operation of a UE according to an embodiment of the present disclosure.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC_INACTIVE state. DRX in the RRC_CONNECTED state (RRC_CONNECTED DRX) will be described below.

A DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in the present disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in the present disclosure. Irrespective of whether DRX is configured, PDCCH monitoring may be restricted during a time period configured as a measurement gap.

The above-described embodiments are combinations of elements and features of the present disclosure in specific forms. The elements or features may be considered selective unless mentioned otherwise. Each element or feature may be implemented without being combined with other elements or features. Further, the embodiments of the present disclosure may be configured by combining some elements and/or some features. Operation orders described in the embodiments of the present disclosure may be rearranged. Some constructions or features of any one embodiment may be included in another embodiment or may be replaced with corresponding constructions or features of another embodiment. It is obvious that claims that are not explicitly cited in the appended claims may be presented in combination as an embodiment of the present disclosure or included as a new claim by subsequent amendment after the application is filed.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is applicable to UEs, BSs, or other apparatuses in a wireless mobile communication system.

1. A method of performing initial cell access by a user equipment (UE) in a 3rd generation partnership project (3GPP)-based wireless communication system, the method comprising:
receiving a physical broadcast channel (PBCH) signal in a synchronization signal block (SSB);
receiving system information block 1 (SIB1)-scheduling information in a first control resource set (CORESET) based on the PBCH signal; and
receiving an SIB1 through a physical downlink shared channel (PDSCH),
wherein the UE is a second type of UE with reduced capability to support a smaller maximum bandwidth than a first type of UE among different types of UEs supported in the 3GPP-based wireless communication system, and
wherein even though the PBCH signal received by the UE is configured the same as a PBCH signal received by the first type of UE, the SIB1 received by the UE comprises a second type of SIB1 different from a first type of SIB1 received by the first type of UE.

2. The method of claim 1, wherein the SIB1-scheduling information comprises both scheduling information for the first type of SIB1 and scheduling information for the second type of SIB1.

3. The method of claim 1, wherein even though the UE receives same SIB1-scheduling information as the first type of UE, the UE receives the second type of SIB1 that is not received by the first type of UE.

4. The method of claim 1, wherein the SIB1-scheduling information is downlink control information (DCI) received through a physical downlink control channel (PDCCH), and
wherein SIB1-scheduling information received by the first type of UE and SIB1-scheduling information received by the second type of UE are different in at least one of a DCI size, a related radio network temporary identifier (RNTI), or cyclic redundancy check (CRC) masking.

5. The method of claim 4, wherein the first CORESET is related to both the SIB1-scheduling information received by the first type of UE and the SIB1-scheduling information received by the second type of UE.

6. The method of claim 1, wherein the first CORESET is a part of a CORESET monitored by the first type of UE.

7. The method of claim 1, wherein the first CORESET is obtained by applying a specific time offset or a specific frequency offset to a CORESET monitored by the first type of UE.

8. The method of claim 1, wherein the UE receives the second type of SIB1 at a location obtained by applying a specific time offset or a specific frequency offset to a location of the first type of SIB1.

9. A processor-readable storage medium configured to store a program for executing the method of claim 1.

10. A device configured to perform initial cell access in a 3rd generation partnership project (3GPP)-based wireless communication system, the device comprising:
a memory configured to store instructions; and
a processor configured to execute the instructions to:
receive a physical broadcast channel (PBCH) signal in a synchronization signal block (SSB);
receive system information block 1 (SIB1)-scheduling information in a first control resource set (CORESET) based on the PBCH signal; and
receive an SIB1 through a physical downlink shared channel (PDSCH),
wherein the device is a second type of device with reduced capability to support a smaller maximum bandwidth than a first type of device among different types of devices supported in the 3GPP-based wireless communication system, and
wherein even though the PBCH signal received by the device is configured the same as a PBCH signal received by the first type of device, the SIB1 received by the device comprises a second type of SIB1 different from a first type of SIB1 received by the first type of device.

11. The device of claim 10, further comprising a transceiver configured to transmit and receive a radio signal under control of the processor, wherein the device is a user equipment (UE) operating in the 3GPP-based wireless communication.

12. The device of claim 10, wherein the device is an application-specific integrated circuit (ASIC) or a digital signal processing device.

13. A method of transmitting a signal by a base station in a 3rd generation partnership project (3GPP)-based wireless communication system, the method comprising:
transmitting a physical broadcast channel (PBCH) signal in a synchronization signal block (SSB);
transmitting system information block 1 (SIB1)-scheduling information in a first control resource set (CORESET) based on the PBCH signal; and
transmitting an SIB1 through a physical downlink shared channel (PDSCH),
wherein the base station supports both a first type of user equipment (UE) and a second type of UE with reduced capability to support a smaller maximum bandwidth than the first type of UE, and
wherein the base station transmits a same PBCH signal commonly to the first type of UE and the second type of UE and transmits to the second type of UE a second type of SIB1 different from a first type of SIB1 for the first type of UE.

14. A base station configured to transmit a signal in a 3rd generation partnership project (3GPP)-based wireless communication system, the base station comprising:
a memory configured to store instructions; and
a processor configured to execute the instructions to:
transmit a physical broadcast channel (PBCH) signal in a synchronization signal block (SSB);
transmit system information block 1 (SIB1)-scheduling information in a first control resource set (CORESET) based on the PBCH signal; and
transmit an SIB1 through a physical downlink shared channel (PDSCH),
wherein the processor is configured to support both a first type of user equipment (UE) and a second type of UE with reduced capability to support a smaller maximum bandwidth than the first type of UE, and
wherein the processor is configured to transmit a same PBCH signal commonly to the first type of UE and the second type of UE and transmit to the second type of UE a second type of SIB1 different from a first type of SIB1 for the first type of UE.
